(19) United States
(12) Patent Application Publication
(10) Pub. No.: US 2002/0070874 A1
(43) Pub. Date: Jun. 13, 2002

(54) Apparatus and method for tracking stolen articles

(76) Inventors: George Williams, Weston, FL (US); Mehrdad Esfandi, Allen, TX (US); Scott Bergen, McKinney, TX (US)

Correspondence Address: JOHN C. SMITH, ESQ., 4800 NORTH FEDERAL HIGHWAY, SUITE A-207, BOCA RATON, FL, 33431, US

(21) Appl. No.: 09/876,433

(22) Filed: Jun. 7, 2001

Related U.S. Application Data
(60) Provisional application No. 60/210,327, filed on Jun. 8, 2000.

(51) Int. Cl. G08B 5/22

(52) U.S. Cl. 340/825.49; 340/568.7; 340/572.8

(57) ABSTRACT

A tracking device which allows law enforcement officers to electronically monitor money stolen from a bank. The tracking device fits within a stack of bills in a teller's drawer or a bank's vault. When activated, it transmits a beacon signal that continuously runs for the duration of the battery. The tracking device automatically sends a signal to either a fixed monitoring station such as a local police station or to a mobile monitoring station, such as a helicopter or police car, and provides continual tracking of the thief in possession of the stolen money. By knowing the location of the money, the police can track and apprehend the perpetrators. It is designed to be a circuit card smaller than a dollar bill and thin enough to be concealed inside a stack of bills, thereby allowing it to be placed into a stack of money undetected. The device can be water-proofed to prevent it from shorting out if placed in by the thief. In addition, it can be made flexible to further aid its concealment within a stack of paper bills. Alternative embodiments allow variations of the tracking device to be placed within other objects of value. An alternative embodiment allows the tracking device to be automatically activated when it is taken past the door of the building where it is stored.

### TECHNICAL FIELD

The present invention relates to the tracking and recovery of the stolen articles. In particular, it relates to the electronic tracking of cash stolen from a bank or other institution via an electronic signaling device placed within date stack of cash which transmits location information to the authorities as the cash is moved from location to location.

### BACKGROUND ART

Historically, armed robberies of financial institutions have been a significant problem. In order to prevent such activity, banks and other financial institutions have tried a number of methods to discourage thieves and/or to capture the thieves and recover the stolen cash.

One prior art method has been to place an exploding dye device inside of a bundle of cash. The bundle would typically be kept in the cash drawer of the bank. When the thief robbed the bank, the teller would select that bundle and place it in with the other cash. The devices are timed to explode after a predetermined time. When they explode, the devices cover the stolen cash with a dye which renders the cash useless to the thieves. While this approach prevents the thieves from having the benefit of the theft, if it does not help the police to locate and apprehend the thieves. It would be advantageous to have a system which would allow the police to track the location of the thieves without their knowledge such that the thieves could b apprehended and the stolen cash could be recovered.

While addressing the basic desirability of using discouraging theft, the prior art has failed to provide a system capable of tracking a thief after the thief has left the scene of the crime, and the tracking device which is inexpensive to manufacture, who is minimum in size, and can be used without the thieves knowledge.

### SUMMARY OF THE INVENTION

The present invention solves the foregoing problems by providing a tracking device which allows law enforcement officers to electronically monitor money stolen from a bank. The tracking device is sized to fit within a stack of bills in a teller's drawer or a bank's vault. When the tracking device is activated, it transmits a beacon signal that continuously runs for the duration of the battery. Thus, the tracking device would automatically send a signal to either a fixed monitoring station such as a local police station or to a mobile monitoring station, such as a helicopter or police car, allowing for continual tracking of the thief in possession of the stolen money. By knowing the location of the money, the police can track and apprehend the perpetrators. It is designed to be a circuit card smaller than a dollar bill and thin enough to be concealed inside a stack of bills, thereby allowing it to be placed into a stack of money undetected. Further, the device can be water-proofed and made flexible, which will have no effect on its ability to be continually tracked, but would prevent someone from shorting out the device in liquid. Alternative embodiments allow variations of the tracking device to be placed within other objects of value. An alternative embodiment allows the tracking device to be automatically activated when it is taken past the door of the building where it is stored.

### BRIEF DESCRIPTION OF THE DRAWINGS

FIG. 1 is a circuit layout of the tracking device on a printed circuit board substrate with integrated circuit components, power supply, trigger switch, and antenna.

FIG. 2 illustrates a preferred embodiment of the tracking device transmitter, it contains an antennae, an amplifier, upconverter, control processor, switch, battery, input/output connector with options for programming and re-charging.

FIG. 3A is a an alternative preferred embodiment of the tracking device which includes a transponder mode. In this embodiment, an additional receiver and antennae are added to the amplifier, upconverter, modulator, control processor. The transponder variation allows the device to be triggered remotely via radio frequency, cellular telephone, etc.

FIG. 3B illustrates a circuit board layout of the device shown in FIG. 3A.

FIG. 4A is an alternative preferred embodiment of the tracking device with a transponder. In this embodiment, the transponder and the receiver share one antennae which is attached to a frequency duplexor to allow different frequencies for transmitting and receiving.

FIG. 4B illustrates a circuit board layout of the device shown in FIG. 4A.

FIG. 5 is a preferred embodiment of the tracking device which is designed for use with a mobile tracking station such as a van or helicopter. It includes a direction finding array system, a guard antennae and transmitter antennae into a system that can be deployed inside the vehicle used for tracking. This system can be designed to find to a degree or better the angle to the beacon once it is activated and through the transmitter it will interrogate the beacon and be able to determine range to the tracking device.

FIG. 6 is a depicts how a tracking center can determine the location of the device. It is a system that uses existing cellular telephone technology, or a monitoring system similar to a cellular phone network where a plurality of base stations or infrastructure equipment is connected to a central office point or tracking center.

FIG. 7 is a preferred embodiment illustrating the use of global positioning system (GPS) data to determine location information.

### DESCRIPTION OF THE PREFERRED EMBODIMENT

Prior to a detailed description of the figures, a general overview of the features and advantages of the invention will be presented. The invention is designed to help recover small stolen property, such as currency taken during a bank robbery, works of art, jewelry, or other small easily portable valuables. For ease of discussion, the invention will be illustrated in terms of a system to track and recover cash stolen in bank robberies. However, those skilled in the heart will recognize that the invention can be used to protect any number of valuable objects.

A problem associated with theft of cash is that, by its nature, the cash can be easily converted and distributed without detection once the thieves have gotten away from the bank. The more time the thieves have after leaving the scene of the robbery, the less the chance is that the thieves will be apprehended, or that the money will be recovered. The system provided herein is a surreptitious tracking device which is concealed within a package of cash in bank. When the device is taken out of the bank building, it can be activated remotely by the bank, or it can be automatically activated when the thief walks past activation device near the door of the bank.

Preferably, the tracking device is sized to fit within a stack of bills in a teller's drawer or a bank's vault. It can even be fabricated as part of the band which holds the money together. Prior to robbery, the device would be in a dormant state. Once the thief demands cash from the bank teller, the bank teller would select a package of currency which contains the tracking device and include it with other cash from the till. As the thief exits the bank, the tracking device would be activated. This can be done in a variety of ways. For example, a bank teller can activate a transmitter which would signal the tracking device to begin operation. Preferably, the tracking device would be automatically activated without requiring any action on the part of the teller. This can be easily done by having a transmitter positioned near the exits of bank. The transmitter should have an effective range that would only trigger the tracking device when it approaches the exit of the building. The advantage of an automatic activation system is that it does not have to rely on individuals who may be so traumatized by an armed robbery that they forget to activate a tracking device.

Optionally, the transmitter that activates the tracking device can also be set up to detect when the tracking device passes the exit of the bank. In this situation, the transmitter can also automatically contact the appropriate authorities so that they are alerted as soon as possible.

In the preferred embodiment, when the tracking device is activated, it transmits a beacon signal that continuously runs for the duration of the battery. Thus, the tracking device would automatically send a signal to either a fixed monitoring station such as a local police station or to a mobile monitoring station, such as a helicopter or police car, allowing for continual tracking of the thief in possession of the stolen money. Likewise, the tracking device could also communicate with local monitoring stations, such as cellular telephone covers, and transfer GPS location information to them. The advantage of using the existing cellular telephone network is that the infrastructure is already in place, and the thieves could not get out of range of the tracking system due to be almost universal geographic coverage of cellular telephone towers.

Determining the position of the tracking device by the tracking system can be accomplished in a variety of ways. For example, triangulation systems are well-known in the art and are used in a variety of applications. Preferably, a GPS (i.e. global positioning system, well known in the art) receiver can be built into the tracking device which can then transmit its position information continuously. Receipt of the GPS information by the police will allow them to proceed directly to the thieves, and/or to follow them as they travel. By having up-to-date information as to the location of the money, the police can track and apprehend the perpetrators as quickly as possible.

In the case of a tracking device which is used to recover cash from bank robberies, the tracking device is designed to be a circuit card smaller than a dollar bill and thin enough to be concealed inside a stack of bills, thereby allowing it to be placed into a stack of money undetected. Further, the device can be water-proofed and made flexible, which will have no effect on its ability to be continually tracked, but would prevent someone from shorting out the device in liquid. Alternatively, the tracking device could be built into the band typically used to bind a stack of currency together. Likewise, and situations where money is carried in sacks or bags, such as the case in which large amounts of currency are transported by armored vehicles, the tracking device can be concealed within or fabricated as part of those sacks or bags.

Alternative embodiments allow variations of the tracking device to be placed within other objects of value. Those skilled in the art will recognize that, depending on the nature of the particular object of value which is being protected, the tracking device can be fabricated in any convenient form and is not restricted to any particular shape. For example, the tracking device can be embedded in a picture frame or stand used to hold or support a valuable piece of art such as a painting or sculpture. In the case of a valuable item of jewelry, such as a wrist watch, necklace, etc., the tracking device would preferably be fabricated such that it would be substantially concealed within the object. As a result of concealing the tracking device, the thief would not realize that his position was known until apprehension by the police. As was the case above, which was discussed in terms of tracking cash, tracking device is used to protect other valuable articles can be remotely or automatically activated based on the particular circumstances. For example, in the case of a painting stolen from a residence or art gallery, automatic activation can be initiated when it is taken past the door of the building where it belongs.

Likewise, the receiver in the tracking device can be set up to monitor for an activation signal, which when received, will turn on the tracking device. Those skilled in the art will recognize that any suitable system can be used to accomplish this function. For example, radio transmitters and receivers can be used, cellular telephone signals can be used, etc.

In the preferred embodiment, the invention is a beacon homing device mounted on a PC-board substrate. While size is not critical, the preferred embodiment uses a 0.25 inch thick tracking device that is smaller than the size of a dollar bill. The device includes an integrated circuit chip which contains the logic circuits, a battery power supply, and a micro-switch trigger. In the preferred embodiment, the device size uses current cellular phone technology. While current cellular phone technology requires a certain size, those skilled in the art will recognize that as technology improves, sizes can be reduced. The tracking device does not require all of the components of a cellular telephone. In particular, no speaker displays, keypad, etc or associated containment components are necessary. Specifically, the basic device is a generic transmitter with an antennae (of a size appropriate to a selected frequency), components such as an amplifier, upconverter, a control processor necessary to make the transmitter on a circuit-board substrate, a micro-switch which extends out of the device, a battery, and an input/output connector. The micro switch is used to trigger the device into operation. The connector allows the device to be encoded with a uniquely identifiable transmission pattern specific to a particular bank or subunit within the bank. Once the device has been triggered via the micro-switch, the device transmits until the battery runs out. Until the device is triggered, it is in a standby mode which uses little or no power, which in turn allows substantial shelf life before the replacement or recharging is required.

And alternative preferred embodiment adds a receiver and another antennae/which would allow the device to transmit and receive. This allows a coded transmission to trigger devices individually or in groups. Once in operation, the device emits the beacon signal continuously until the battery expires. Additionally, the device can receive an interrogation and reply to enable a tracking system to determine two-way range easily, the constant beacon signal would be briefly interrupted to allow for the interrogation response. In this improvement, the battery would constantly supply low level power to the receiver but not to the transmitter until it is triggered. In this embodiment, the device may be rechargeable through the programming connector. Since mechanical triggering is not required, a primary advantage of this design is that the device could be sealed to prevent a chemical or water attack on the device.

A further improvement and option on the device would be to put in a frequency duplexor and use one antennae. The advantage of this design is primarily cost efficiency.

Finally, the device in any of the previous forms can be constructed using flexible substrate. This allows the device to be flexible and hence less detectable by physical manipulation when inserted into a stack of bills.

Alternatively, another preferred embodiment of the device is a tracking system used in conjunction with a van or helicopter. In this embodiment of a transponder uses a range receiver, range processor, transmitter, a clock device, multiple direction finding receivers, a direction finding processor, signal detection processor, display driver and a display. The two limitations of this tracking system are (1) the direction finding system must cover 360 degrees through rotating or using up to four direction finding arrays and cycling the receiver bank between them and (2) the system may not be able to locate the beacon signal underground.

Another alternative embodiment involves tracking the device through a network. The beacon signal could be tracked by a tracking center using TDOA (Time Difference Of Arrival) techniques to determine its location. Similar to a cellular phone network, a plurality of base stations or infrastructure equipment, such as a beacon receiver antenna, receiver, a decoder/processor and a global positioning system to generate the time and the interface which would be connected either by telephone, telecommunications networks T1 or E1, or by microwave relay to a central location or tracking center. The preferred concept utilizes a TDOA technique to determine the location of the beacon. Here, the base station or infrastructure equipment uses the decoder/processor to log the encoded beacon signal and the time of arrival as set-up in the scheme and sends that information back to the central tracking center. By utilizing the time of arrival data from three or more base stations, the central tracking center can then calculate the location of the device. The primary advantage of this variation is that a plurality of devices could be tracked simultaneously, allowing for cases of multiple robberies or additional uses of the device

A tracking center for a city or other designated geographic area could be one or two computers set up in redundant configuration such that one of them is always on with a forward of the information to local law enforcement. Another option is to have a manned station set-up with any type of computer where algorithms could be programmed into it, such as a Pentium III (™) desktop PC that has the computing power necessary to track hundreds of simultaneous beacons. We now turn to a detailed discussion of the figures.

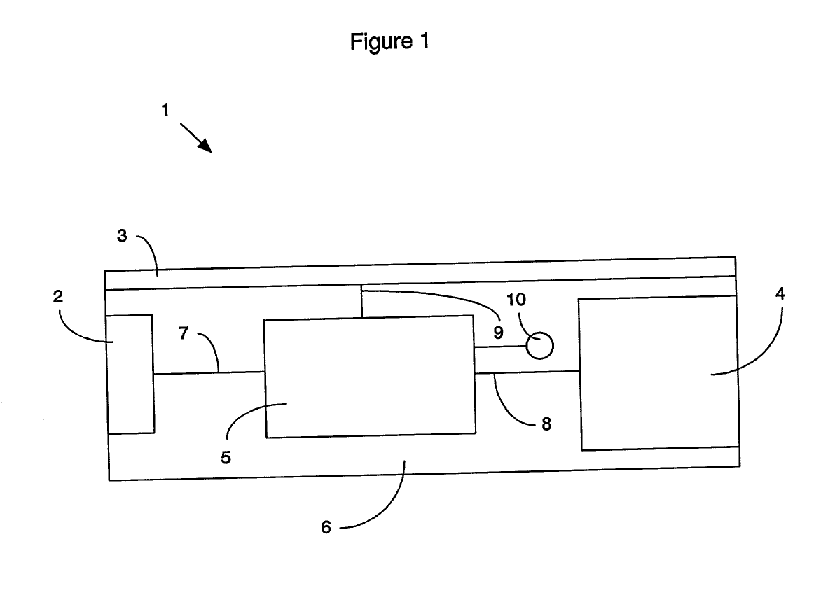

FIG. 1 is an example of a preferred embodiment of the invention in which the tracking device is installed on a tracking device 1. An integrated circuit 5 contains the logical functions of the device, which includes memory, transmitter, receiver, programmable processor, etc. In the preferred embodiment, a programmable processor is incorporated into the integrated circuit 5. However, those skilled in the art will recognize that a much more limited circuit than the programmable processor, even a non-programmable hardwired circuit, can be used to control transmission of the location beacon.

Also shown is a battery power supply 4 connected to the integrated circuit 5 via connection line 8 and supplies the integrated circuit 5 with power. In the preferred embodiment, the integrated circuit 5 includes power management functions to de-activate portions of the circuit 5 which are not being used for the purpose of extending battery life. Power management functions are well-known in the art. Currently, the preferred embodiment uses a lithium or layered battery. However, any suitable battery type can be used.

A micro-switch 10 days also connected to the integrated circuit 5. The micro-switch 10 can be a manual switch that activates the integrated circuit 5 when it is pressed. However, preferably a micro-switch 10 is an automatic switch which activates the integrated circuit 5 under control of a remotely generated signal, which can be generated either from manual activation by a bank teller or other authorized person, or can be automatically generated by a tracking device detection transmitter (not shown in this figure) such as one which might be located at the door of a bank. It is even possible to implement the micro-switch 10 as an RFID tag (either active or passive). RFID tags are well-known in the art. If an RFID tag is used, it can trigger a tracking device detection transmitter which can transmit an activation command to the tracking device 1. Micro-switch can be a separate device as shown, or it can be integrated into integrated circuit 5.

The integrated circuit 5 is attached via connection line 9 to the antenna 3. In this preferred embodiment, a single antenna 3 is duplexed such that it can transmit the location beacon as well as receive commands and information from remote locations.

Programming connector 2 the shown connected to the integrated circuit 5 via connection line 7. Programming connector 2 allows integrated circuit 5 via programmed to specific information, such as identification codes, owner name, etc. It also can be used to instruct integrated circuit 5 as to which type of particular beacon is desired, time intervals between tests for GPS sampling and transmission, etc.

While tracking device 1 can be fabricated from any suitable material, it is preferably fabricated on a flexible substrate 6. In addition, for used in conjunction with currency, it would preferably be fabricated such that it is smaller or equal and size to an individual bill such that it would be less likely to be detected by a thief.

The foregoing example illustrates one method of fabricating tracking device 1. However, those skilled in the art will recognize that has long as the tracking device 1 is capable of performing its functions, the physical embodiment and varying the suit available technologies.

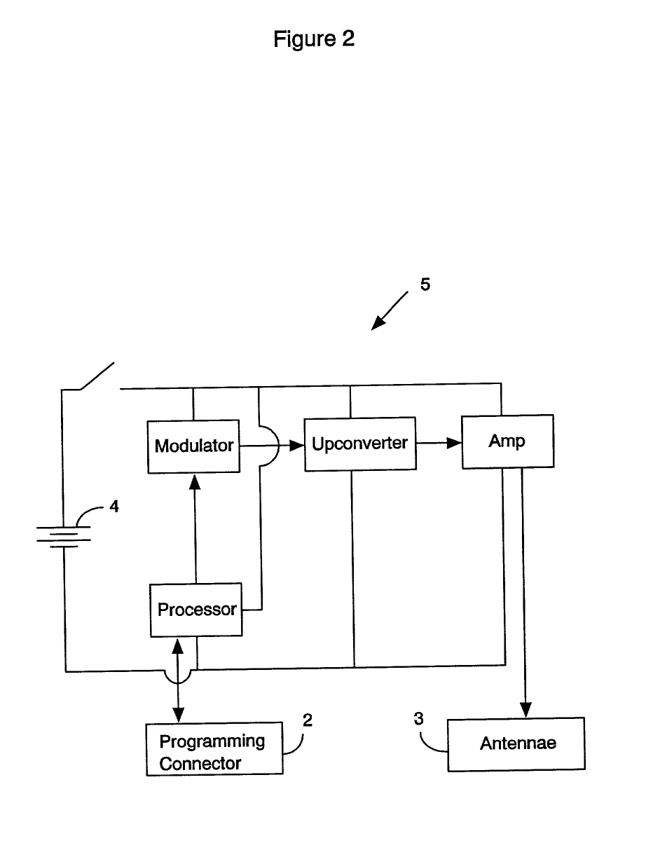

FIG. 2 illustrates a preferred embodiment of the tracking device transmitter. This embodiment contains an antennae 3, a programming connector 2 for initializing and/or reprogramming the tracking device 1, a battery power supply 4, a micro-switch 10 to activate the tracking device 1, and several other functions which may be integrated into the integrated circuit 5 including a modulator, a control processor, an upconverter, and an amplifier. The

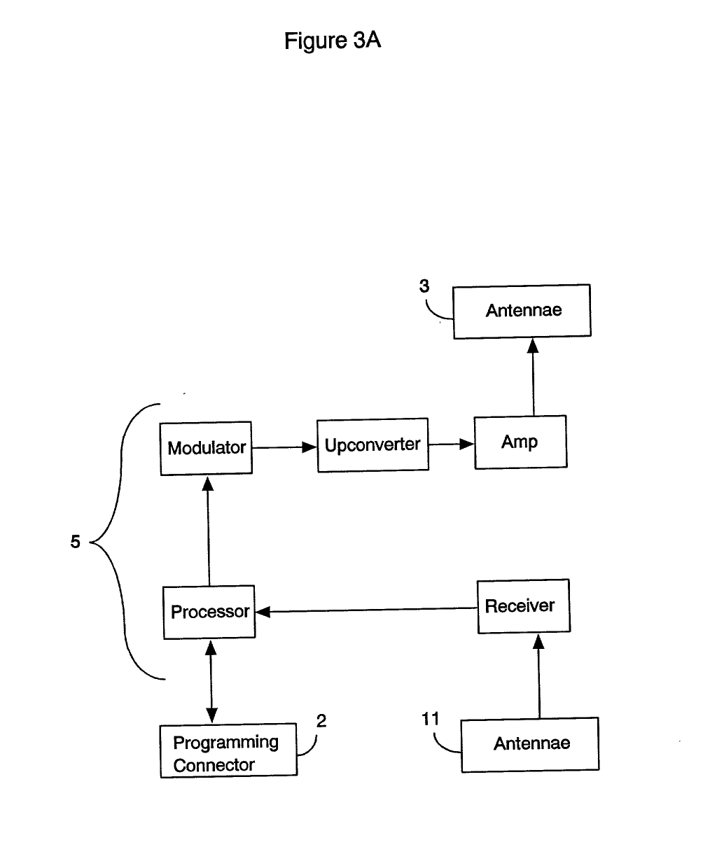

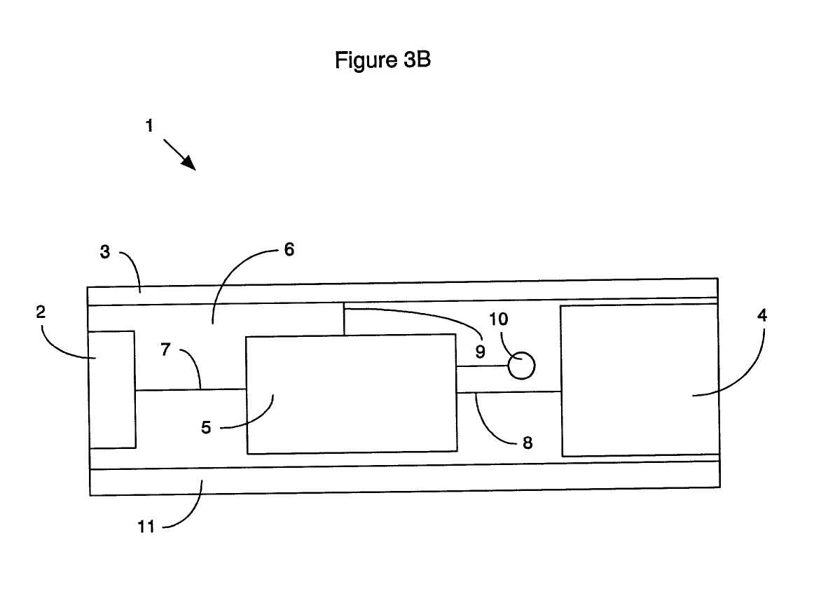

FIG. 3A is an illustration of the circuit layout of an alternative preferred embodiment of the tracking device 1 which includes a transponder mode. In this embodiment, an additional receiver and antennae 11 are added to the amplifier, upconverter, modulator, control processor. The transponder variation allows the tracking device 1 to be triggered remotely via radio frequency, cellular telephone signal, or any other suitable communications medium.

FIG. 3B illustrates a circuit board layout of the device shown in FIG. 3A.

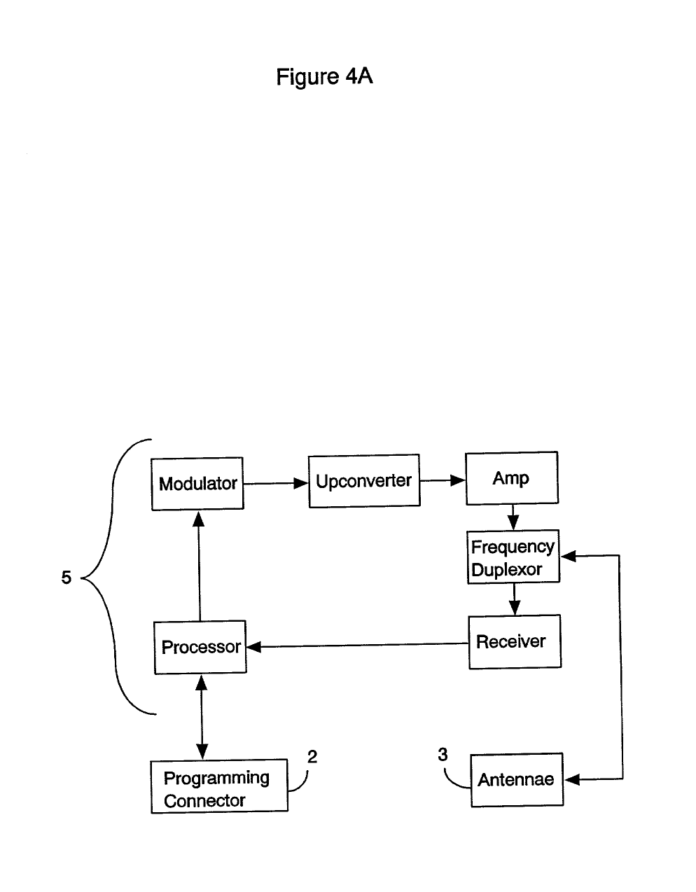

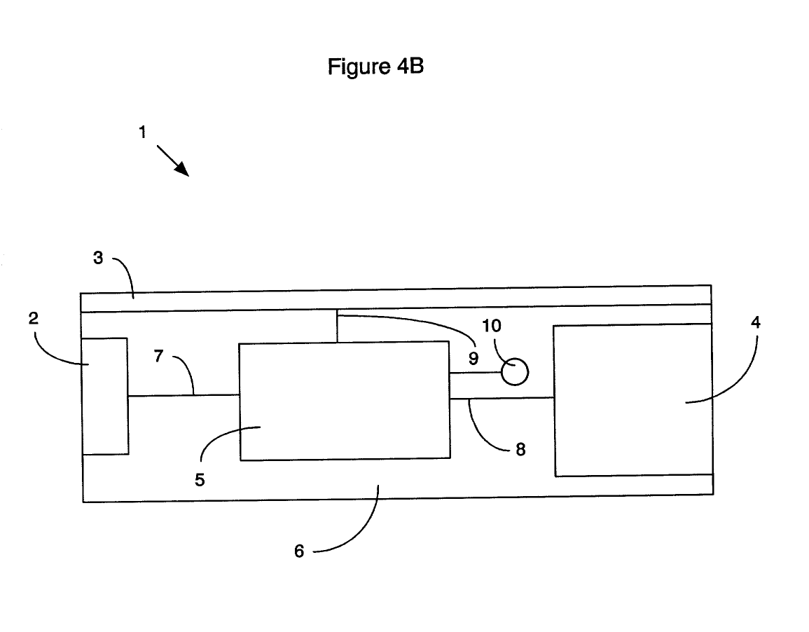

FIG. 4 is an alternative preferred embodiment of the tracking device 1 with a transponder. In this embodiment, the transponder and the receiver share one antennae 3 which is attached to a frequency duplexor to allow different frequencies for transmitting and receiving.

FIG. 4B illustrates a circuit board layout of the tracking device 1 shown in FIG. 4A.

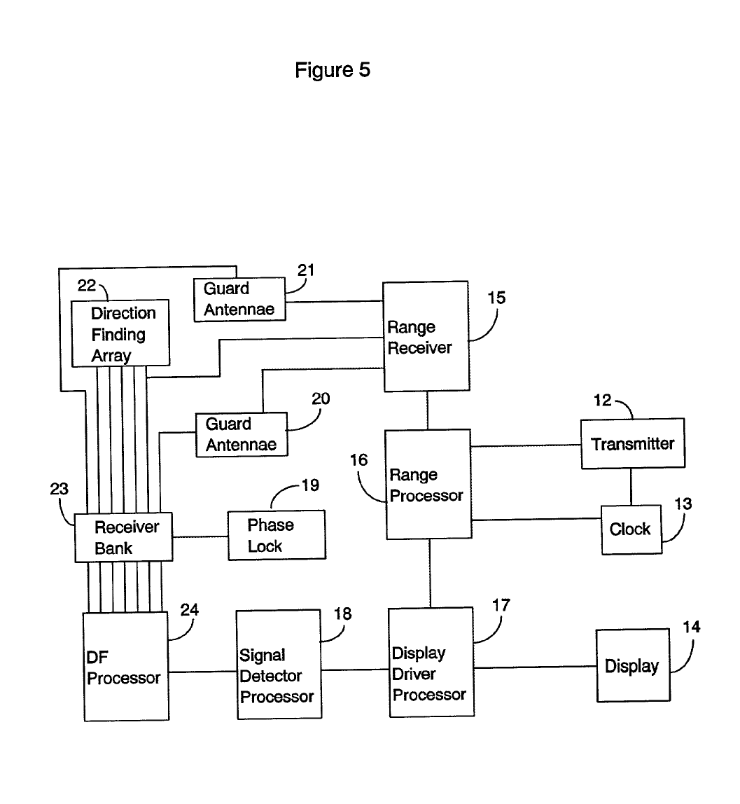

FIG. 5 is a preferred embodiment of the tracking system which is designed for use with a mobile tracking station such as a van or helicopter. It includes a direction finding array system 12-3, 15-19, 22-24, guard antennae 20-21, and display 14 which comprise a system that can be deployed inside a vehicle used for tracking. Direction finding systems such as this are well-known in the art. This system can be designed to find to a degree or better the angle to the beacon once it is activated and through the transmitter it will interrogate the beacon and be able to determine range to the tracking device.

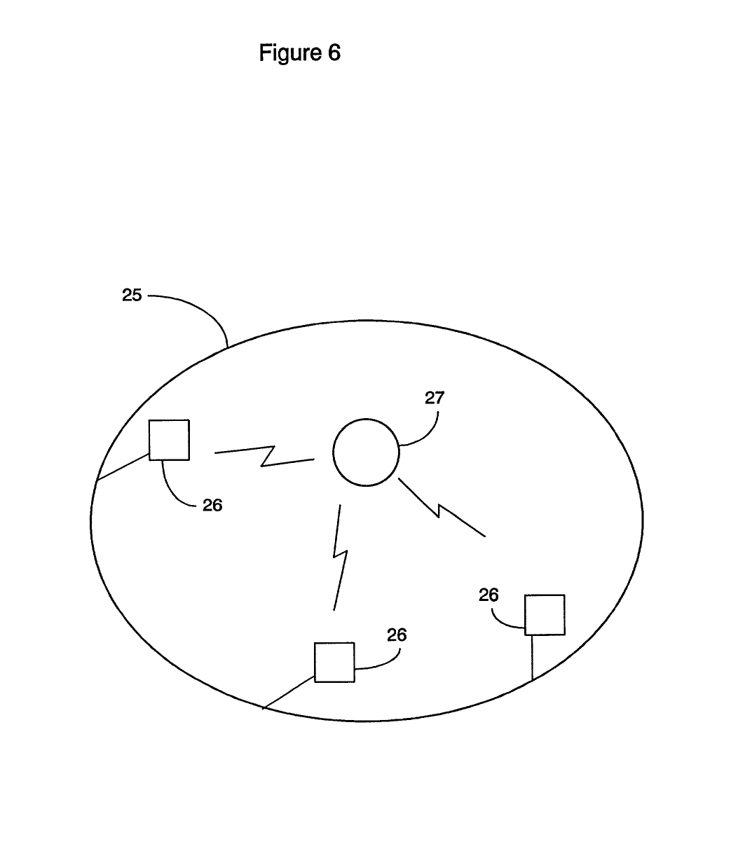

FIG. 6 is a depicts how a fixed location tracking center can determine the location of the tracking device 1. This system can use any suitable monitoring in communication system to implement the tracking function. For example, the system can use existing cellular telephone technology in the following manner. Cellular towers 26 can detect the beacon 27 transmitted by the tracking device 1. Each of the cellular towers 26 which detect the beacon 27 can transmit via any suitable communications network 25 (the communication network can be any suitable technologies such as fiber-optic, microwave, land line, etc.) Known triangulation techniques can be used to determine location of the beacon, but preferably, the begin will include GPS data which can be transmitted to the appropriate authorities. Likewise, instead of a cellular telephone system, the conventional system of radio monitoring stations can be used in conjunction with a radio transmitter in the tracking device 1 which communicates via RF transmission. As can be seen, any suitable monitoring system can be used which has a plurality of base stations or infrastructure equipment is connected to a central office point or tracking center.

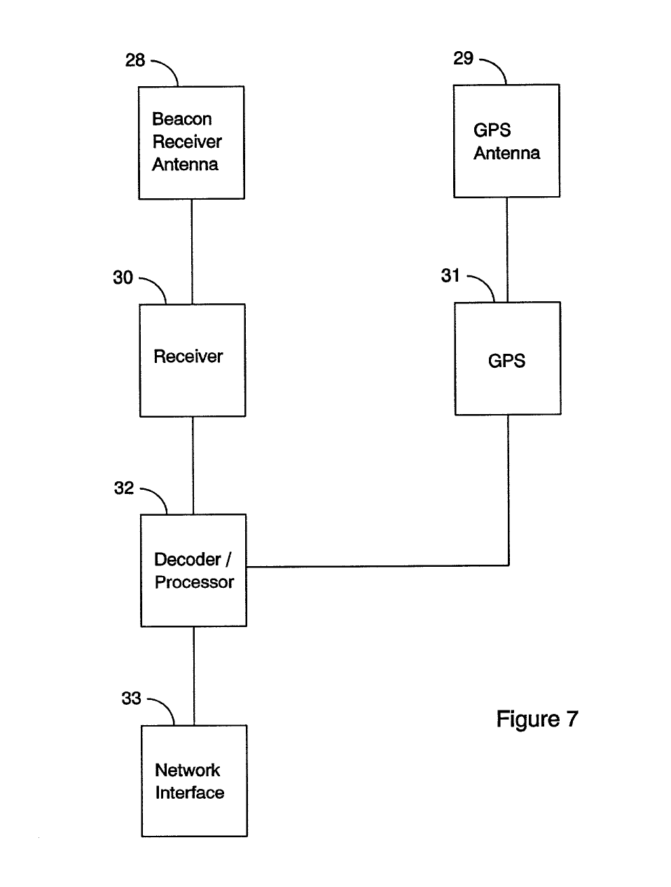

FIG. 7 is a preferred embodiment of a monitoring station which illustrates the use of global positioning system (GPS) data to determine location information. In this embodiment, a GPS antenna 29 inputs GPS data to a GPS decoder 31 which in turn forwards the GPS data to wait decoder processor 32 in the monitoring station. The beacon receiver antenna 28 inputs beacon signals to a receiver 30, which in turn outputs position data to the decoder processor 32. The decoder processor 32 uses the identifying and GPS data sent from the tracking device 1 to produce location information which is forwarded via the network interface 33 to the proper authorities. The network interface can be any suitable interface such as the T1 line, fiber-optic link, microwave link, RF link, land line, etc.

While the invention has been described with respect to a preferred embodiment thereof, it will be understood by those skilled in the art that various changes in detail may be made therein without departing from the spirit, scope, and teaching of the invention. For example, the materials and type of circuitry used to construct the tracking device may be anything suitable for its purpose, the size and shape of the. The type of, if any, can vary in orientation. Likewise, the size of the may vary based on the transport vehicle's limitations, etc. Accordingly, the invention herein disclosed is to be limited only as specified in the following claims.

We claim:

1. An article tracking device, further comprising:
the beacon transmitter;
means to detect when the beacon transmitter is moved beyond the preselected area; and
means to automatically activate the beacon transmitter when it is moved beyond the predetermined location;
whereby the beacon transmitter will automatically activate and transmit position location information when it is moved outside of a preselected area.

2. A device, as in claim 1, where an:
the device is a flexible device sized to fit within a stack of currency.

3. A device, as in claim 1, further comprising:
a GPS receiver having means to determine from GPS satellite data the position of the device;
means to transmit the GPS location data to a tracking station.
